(19) United States
(12) Patent Application Publication
(10) Pub. No.: US 2008/0091608 A1
(43) Pub. Date: Apr. 17, 2008

(54) Method for an OMA multimedia exchange

(75) Inventors: Kuo-Hsun Liao, Taichung City (TW); Chia-Chin Lin, Chaojhou Township (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 11/785,937

(22) Filed: Apr. 23, 2007

(30) Foreign Application Priority Data
Oct. 17, 2006 (TW) 095138169

(51) Int. Cl. H04K 1/00

(52) U.S. Cl. 705/51

(57) ABSTRACT

A method for an Open Mobile Alliance (OMA) multimedia exchange allows a sender to send a multimedia data to a receiver via a rights issuer. The method begins by registering to the rights issuer and sending a pubic key from the sender to the rights issuer. Next, a right object and a content object are sent from the sender to the rights issuer, wherein the right object records a content key encrypted by a private key of the sender. Then, the public key is used by the rights issuer to decrypt the content key, and the right object and the content object are packaged into a DRM content format (DCF) object. Finally, an OMA download is used over the Air (OMA download OTA) to send the DCF object from the rights issuer to the receiver.

### BACKGROUND OF THE INVENTION

1. Field of the Invention

The present invention relates to the technical field of Open Mobile Alliance (OMA) Digital Rights Management (DRM) and, more particularly, to a DRM method using a peer-to-peer (P2P) delivery for multimedia exchange.

2. Description of Related Art

With the rapid development of wireless network technologies, the access bandwidth is rapidly increased. A handheld device can accordingly access multimedia data via a wireless network. Due to the increased bandwidth, multimedia downloading becomes a fashion, in which DRM is an important technology for multimedia downloading.

U.S. Pat. No. 7,039,615 granted to Gajjala et al. for “Retail Transactions Involving Digital Content in a Digital Rights Management (DRM) System”, has disclosed a solution to overcome a music copyright infringement caused by an online music access method. In this patent, a platform of digital rights management (DRM) software is provided by Microsoft Corp., which is known as Microsoft DRM, in order to deal with the problems of digital music copyright.

The Microsoft DRM software links to a user end through a server, and produces a content key respectively to songs. Namely, when the user end downloads a song via the Internet, a content key corresponding to the song is also downloaded. For the same song, the content key is the same in every downloading. A music file can be played only when the corresponding content key is met. Therefore, during transferring and acquiring a content key, a public key and private key is applied to protect the content key from being cracked.

The Open Mobile Alliance (OMA) has proposed DRM specifications. FIG. 1 is a schematic diagram of an operation of Open Mobile Alliance (OMA) digital rights management (DRM). The content provider 110 uses a content key 150 in encryption and accordingly produces an encrypted DRM file. The encrypted DRM file is named as DRM content format (DCF). A user 130 obtains the encrypted DRM file 140 via a network. The content provider 110 also sends the content key 150 to a right issuer 120. The right issuer 120 produces a right object (RO) 160 in accordance with the content key 150, and sends the right object 160 to the user 130 for playing the encrypted DRM file. In order to save the hardware configuration cost, the content provider 110 and the right issuer 120 can be combined in one host system. A DRM agent of the user 130 acquires the content key 150 from the right object 160 to decrypt the encrypted DRM file and then the DRM file can be used.

However, either the Microsoft DRM or the OMA DRM do not describe how a user can share the self-produced files to another user. Namely, a typical DRM limits the right of sharing a digital content file with others and affects the multimedia propagation.

Therefore, it is desirable to provide an improved DRM method to mitigate and/or obviate the aforementioned problems.

### SUMMARY OF THE INVENTION

An object of the present invention is to provide a method for an Open Mobile Alliance (OMA) multimedia exchange, which allows a peer-to-peer multimedia transfer.

Another object of the present invention is to provide a method for an Open Mobile Alliance (OMA) multimedia exchange, which allows a peer-to-peer multimedia transfer upon the existent OMA specifications to accordingly promote the multimedia propagation.

In accordance with one aspect of the present invention, there is provided a method for an Open Mobile Alliance (OMA) multimedia exchange, which allows a sender to send a multimedia data to a receiver via a rights issuer. The method includes the steps: (A) registering to the rights issuer and sending a pubic key from the sender to the rights issuer; (B) sending a right object and a content object from the sender to the rights issuer, wherein the right object records a content key encrypted by a private key of the sender; (C) using the public key by the rights issuer to decrypt the content key, and packaging the right object and the content object into a DRM content format (DCF) object; (D) using an OMA download over the Air (OMA download OTA) to send the DCF object from the rights issuer to the receiver.

In accordance with another aspect of the present invention, there is provided a method for an Open Mobile Alliance (OMA) multimedia exchange, which allows a sender to send a multimedia data to a receiver via a rights issuer. The method includes the steps: (A) sending a right object from the sender to the rights issuer, and sending a DCF content object, which is packed into a DCF format, to the receiver, wherein the right object records a content key; (B) sending a right object request from the receiver to the rights issuer; and (C) using an OMA download OTA to send the right object from the rights issuer to the receiver.

In accordance with further aspect of the present invention, there is provided a method for an Open Mobile Alliance (OMA) multimedia exchange, which allows a sender to send a multimedia data to a receiver via a rights issuer. The method includes the steps: (A) the sender registering to the rights issuer and sending a pubic key to the rights issuer, and the rights issuer sending a public key of the receiver to the sender; (B) the sender assigning an RI_URL (rights issuer uniform resource locator) field of a content object to a URL of the sender, and encrypting a right object with the public key of the receiver first and then with a private key of the sender to thereby produce an encrypted right object; (C) the sender packaging the encrypted right object and the content object into a DRM content format (DCF) object and sending the DCF object to the receiver; (D) the receiver sending a right object request to the rights issuer according to the RI_URL field of the content object when an identification of the encrypted right object fails; (E) the rights issuer activating a four-pass registration according to the RI_URL field of the content object and directing the registration to the sender for sending the public key of the sender to the receiver.

In accordance with still another aspect of the present invention, there is provided a method for an Open Mobile Alliance (OMA) multimedia exchange, which allows a sender to send a multimedia data to a receiver via a rights issuer. The method includes the steps: (A) the sender registering to the rights issuer and sending a pubic key to the rights issuer, and the rights issuer sending a public key of the receiver to the sender; (B) the sender assigning an RI_URL (rights issuer uniform resource locator) field of a content object to a URL of the sender, and encrypting a right object with the public key of the receiver first and then with a private key of the sender to thereby produce an encrypted right object; (C) the sender packaging the content object into a DRM content format (DCF) object and sending the DCF object to the receiver; (D) the receiver sending a right object request to the rights issuer according to the RI_URL field of the content object; (E) the rights issuer activating a four-pass registration according to the RI_URL field of the content object and directing the registration to the sender for sending the public key of the sender to the receiver; (F) the rights issuer producing a right object acquisition protocol (ROAP) trigger event to the receiver and sending the encrypted right object to the receiver.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a typical operation of Open Mobile Alliance (OMA) digital rights management (DRM);

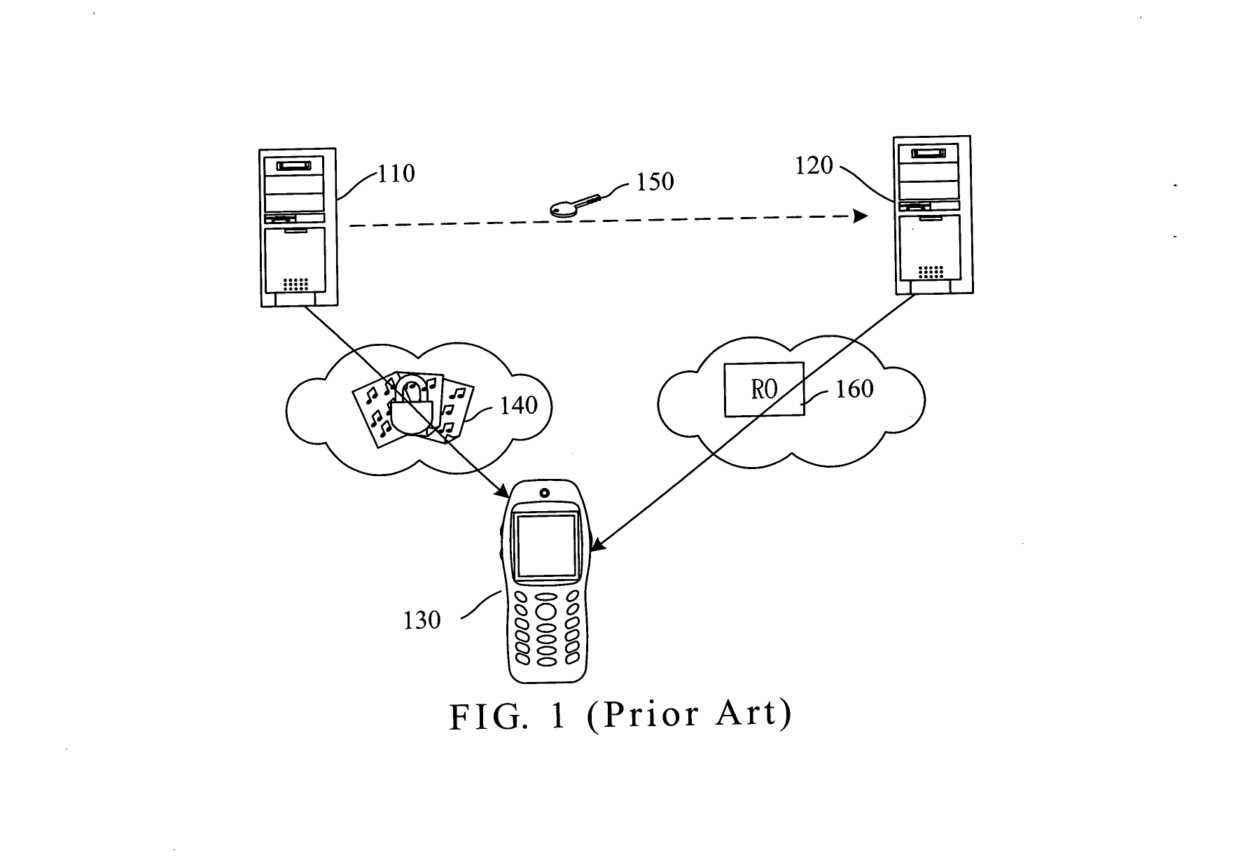

FIG. 2 is a schematic diagram of an embodiment of a method for an Open Mobile Alliance (OMA) multimedia exchange in accordance with the invention;

FIG. 3 is a schematic diagram of another embodiment of a method for an Open Mobile Alliance (OMA) multimedia exchange in accordance with the invention;

FIG. 4 is a schematic diagram of a further embodiment of a method for an Open Mobile Alliance (OMA) multimedia exchange in accordance with the invention; and

FIG. 5 is a schematic diagram of a still further embodiment of a method for an Open Mobile Alliance (OMA) multimedia exchange in accordance with the invention.

### DETAILED DESCRIPTION OF THE PREFERRED EMBODIMENT

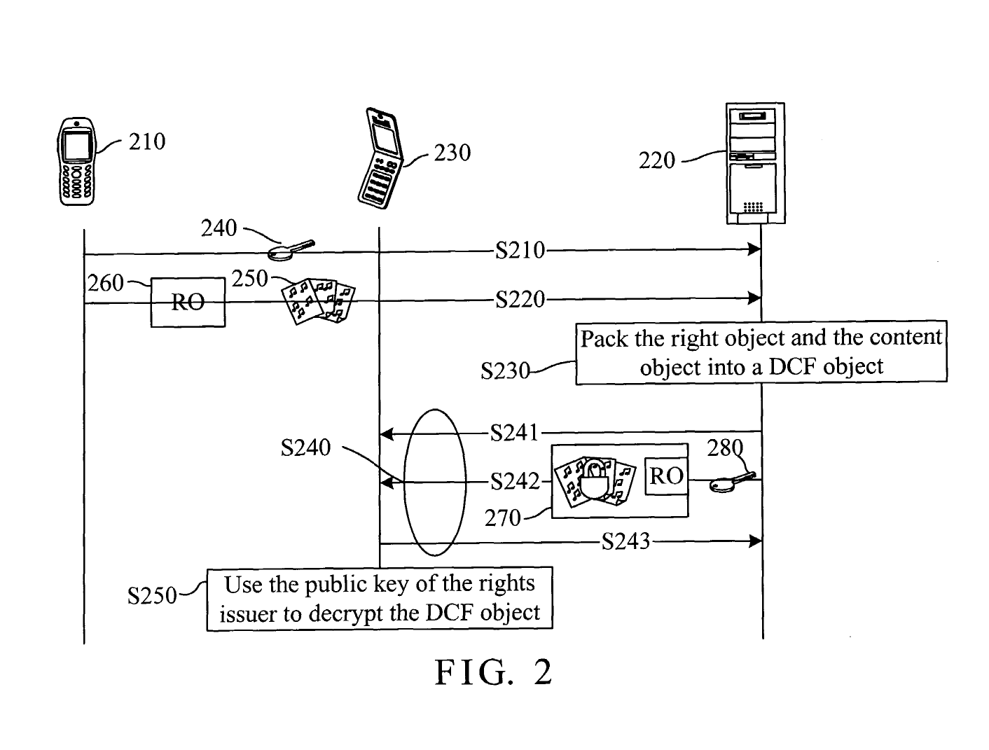

FIG. 2 is a schematic diagram of an embodiment of the method for an Open Mobile Alliance (OMA) multimedia exchange in accordance with the invention, which allows a sender 210 to send multimedia data to a receiver 230 via a rights issuer 220. As shown in FIG. 2, at first, the sender 210 registers to the rights issuer 220 and sends a pubic key 240 of the sender 210 to the rights issuer 220 (step S210)

In step S220, the sender 210 sends a right object 260 and a content object 250 to the rights issuer 220. The right object records a content key that is encrypted by a private key of the sender 210.

In step S230, the right object 260 and the content object 250 are packaged into a DRM content format (DCF) object 270. The rights issuer 220 uses the public key 240 of the sender 210 to decrypt the content key encrypted by the private key of the sender 210.

In step S240, the rights issuer 220 uses an OMA download over the Air (OMA download OTA) to send the DCF object to the receiver 230. An RSA algorithm is applied to encrypt and decrypt the transfer between the receiver 230 and the rights issuer 220.

The RSA encryption and decryption proposed by Ron Rivest, Adi Shamir, and Len Adleman in 1978 has provided a one-way trapdoor function, which is based on a factoring exponential function. The RSA encryption and decryption is a widely used public-key cryptosystem currently, which is a block cipher and has public and private keys. The security of RSA encryption and decryption is based on the difficulty of prime factorization, which uses two enormous primes to express the public and private keys. Accordingly, the public key is not equal to the private key, and their greatest common factor is one. However, the two keys have a mutually corresponding relationship on encryption/decryption.

When a sender performs an encryption with a public key of a receiver, the receiver can performs a decryption with the private key. In this case, others can receive the encrypted data but cannot decrypt it without the private key. Thus, the encrypted data is protected. Such a way is referred to as a conventional RSA encryption and decryption.

Similarly, when a sender performs an encryption with a private key of the sender, the receiver can perform a decryption with the public key of the sender. When an encrypted data received by the receiver is decrypted with the public key of the sender, it indicates that the received data is really sent by the sender, which is the applied principle of digital signatures.

Step S240 consists of steps S241-S243. In step S241, the rights issuer 220 notifies the receiver 230 of acquiring the DCF object 270. In step S242, the receiver 230 uses the OMA download OTA to acquire the DCF object 270 and a public key 280 of the rights issuer 220. In step S243, the receiver 230 sends a download complete signal to the rights issuer 220 to thereby end the transfer between the receiver 230 and the rights issuer 220.

In step S250, the receiver 230 uses the public key 280 of the rights issuer 220 to decrypt the DCF object. Accordingly, the invention can complete the peer-to-peer multimedia share in the OMA-DRM configuration.

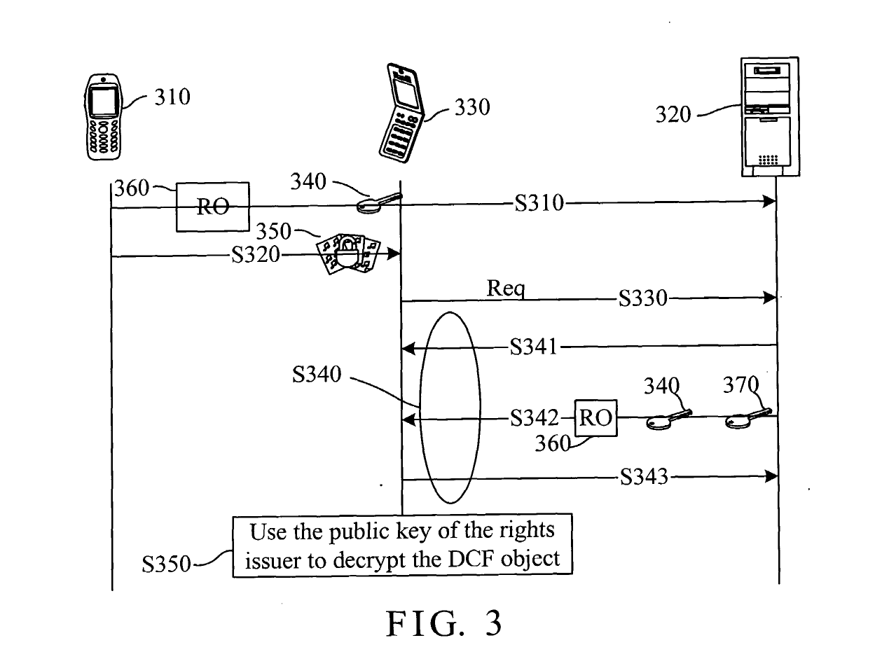

FIG. 3 is a schematic diagram of another embodiment of the method for an Open Mobile Alliance (OMA) multimedia exchange in accordance with the invention. In this embodiment, the sender 310 sends a multimedia data to the receiver 330 via the rights issuer 320.

In step S310, the sender 310 sends a right object 360 and a content key 340 to the rights issuer 320. The right object 360 records a content key. In step S320, the sender 310 sends a content object 350 to the receiver 330. The content object 350 is encrypted by the content key 340. In step S330, the receiver 330 requests the rights issuer 320 to send a right object.

In step S340, the right issuer 320 uses the OMA download OTA to send the right object 360 to the receiver 330. An RSA algorithm is applied to encrypt and decrypt the transfer between the receiver 330 and the rights issuer 320.

Step S340 consists of steps S341 to S343. In step S341, the rights issuer 320 notifies the receiver 330 of acquiring the right object 360. In step S342, the receiver 330 uses the OMA download OTA to acquire the right object 360, the content key 340 and a public key 370 of the rights issuer 320. In step S343, the receiver 330 sends a download complete signal to the rights issuer 320 to thereby end the transfer between the receiver 330 and the rights issuer 320.

In step S350, the receiver 330 uses the public key 370 of the right issuer 320 to decrypt the right object 360.

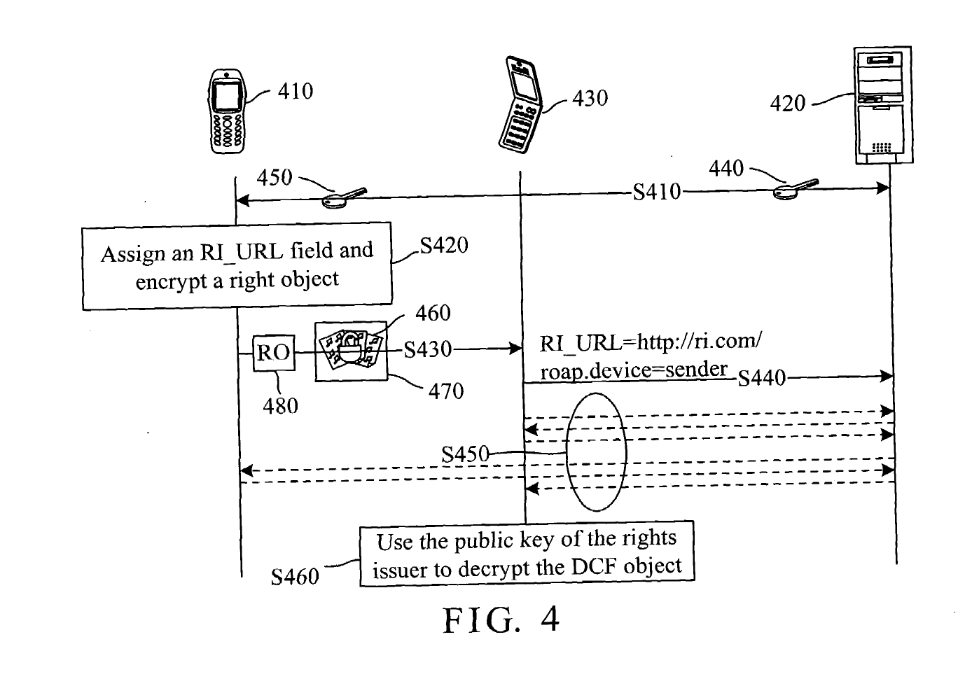

FIG. 4 is a schematic diagram of a further embodiment of the method for an Open Mobile Alliance (OMA) multimedia exchange in accordance with the invention. In this embodiment, the sender 410 sends a multimedia data to the receiver 430 via the rights issuer 420.

In step S410, the sender registers 410 to the rights issuer 420 and sends a pubic key 440 of the sender 410 to the rights issuer 420. The rights issuer 420 sends a public key 450 of the receiver 430 to the sender 410.

In step S420, the sender assigns an RI_URL (rights issuer uniform resource locator) field of a content object 460 to a URL of the sender 410, and encrypts a right object with the public key 450 of the receiver 430 first and then a private key (not shown) of the sender 410 to thereby produce an encrypted right object.

In step S430, the sender 410 packages the content object 460 into a DRM content format (DCF) object 470, and sends the both the encrypted right object 480 and DCF object 470 to the receiver 430.

In step S440, the receiver 430 has no the public key 440 of the sender 410, which causes a fail of identifying the encrypted right object. In this case, the receiver 430 sends a right object request to the rights issuer 420 in accordance with the RI_URL field of the content object 460.

In step S450, since the RI_URL field does not record the URL of the rights issuer 420, the rights issuer 420 accordingly determines that the right object request asks the sender 410 recorded in the RI_URL for the right object, rather than itself. Therefore, the rights issuer 420 activates a four-pass registration in accordance with the RI_URL field of the content object 460 and directs the registration to the sender 410 for sending the public key 440 of the sender 410 to the receiver 430. The four-pass registration is a standard procedure defined in the OMA standard procedure, and thus a detailed description is deemed unnecessary.

In step S460, the receiver 430 uses the public key 440 of the sender 410 to identify the encrypted right object.

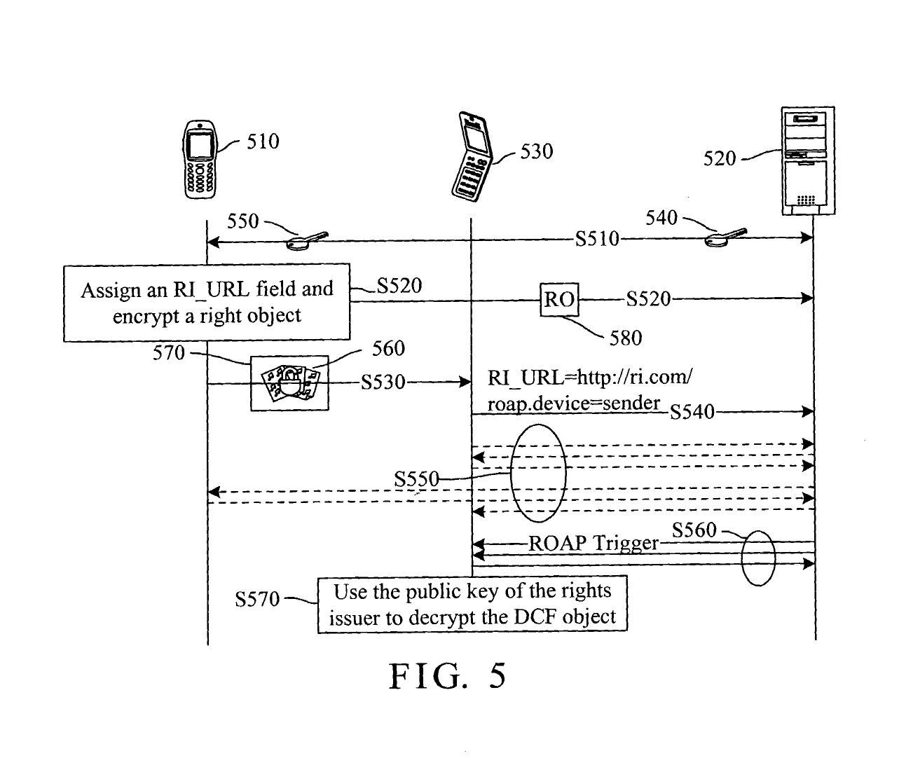

FIG. 5 is a schematic diagram of a still further embodiment of the method for an Open Mobile Alliance (OMA) multimedia exchange in accordance with the invention. In this embodiment, the sender 510 sends a multimedia data to the receiver 530 via the rights issuer 520.

In step S510, the sender 510 registers to the rights issuer 520 and sends a pubic key 540 of the sender 510 to the rights issuer 520, and the rights issuer 520 sends a public key 550 of the receiver 530 to the sender 510.

In step S520, the sender 510 assigns an RI_URL (rights issuer uniform resource locator) field of a content object 560 to a URL of the sender 510, and encrypts a right object with the public key 550 of the receiver 530 first and then with a private key (not shown) of the sender 510 to thereby produce an encrypted right object 580. The sender 510 sends the encrypted right object 580 to the rights issuer 520.

In step S530, the sender 510 packages the content object 560 into a DRM content format (DCF) object 570 and sends the DCF object 570 to the receiver 530.

In step S540, the receiver 530 does not have the right object, which causes a failure of identifying the right of the content object 560. In this case, the receiver 530 sends a right object request to the rights issuer 520 in accordance with the RI_URL field of the content object 560.

In step S550, since the RI_URL field does not record the URL of the rights issuer 520, the rights issuer 520 accordingly determines that the right object request asks the sender 510 recorded in the RI_URL for the right object, rather than itself. Therefore, the rights issuer 520 activates a four-pass registration in accordance with the RI_URL field of the content object 560 and directs the registration to the sender 510 for sending the public key 540 of the sender 510 to the receiver 530.

In step S560, the rights issuer 520 produces a right object acquisition protocol (ROAP) trigger event to the receiver 530 and sends the encrypted right object to the receiver 530.

In step S570, the receiver 530 uses the public key 540 of the sender 510 to identify the encrypted right object.

In view of the foregoing, it is known that, upon the OMA standards, the invention can overcome the prior problem and support a peer-to-peer multimedia transfer. In addition, the invention can provide peer-to-peer multimedia sharing under the OMA-DRM configuration, to thereby overcome the typical DRM limit at the right of sharing digital content files with others and increase the multicast propagation.

Although the present invention has been explained in relation to its preferred embodiment, it is to be understood that many other possible modifications and variations can be made without departing from the spirit and scope of the invention as hereinafter claimed.

What is claimed is:

1. A method for an Open Mobile Alliance (OMA) multimedia exchange, which allows a sender to send a multimedia data to a receiver via a rights issuer, the method comprising the steps of:
(A) registering to the rights issuer and sending a pubic key of the sender from the sender to the rights issuer;
(B) sending a right object and a content object from the sender to the rights issuer, wherein the right object records a content key encrypted by a private key of the sender;
(C) packaging the right object and the content object into a DRM content format (DCF) object by the rights issuer; and
(D) using an OMA download over the Air to send the DCF object from the rights issuer to the receiver.

2. The method as claimed in claim 1, wherein an RSA algorithm is applied to encrypt and decrypt a transfer between the receiver and the rights issuer.

3. The method as claimed in claim 2, wherein the receiver uses a public key of the rights issuer to decrypt the DCF object.

4. The method as claimed in claim 1, wherein step (D) comprises the steps:
(D1) the rights issuer notifying the receiver of acquiring the DCF object;
(D2) the receiver acquiring the DCF object;
(D3) the receiver sending a download complete signal to the rights issuer to thereby end the transfer between the receiver and the rights issuer.

5. The method as claimed in claim 1, wherein step (C) comprises the step (C1): using the public key of the sender to decrypt the content key recorded in the right object by the rights issuer and accordingly obtaining a decrypted content key for identifying that the content key is surely sent by the sender.

6. A method for an Open Mobile Alliance (OMA) multimedia exchange, which allows a sender to send a multimedia data to a receiver via a rights issuer, the method comprising the steps of:
(A) sending a right object from the sender to the rights issuer, and sending a content object from the sender to the receiver, wherein the right object records a content key associated with the content object;
(B) sending a right object request from the receiver to the rights issuer; and
(C) using an OMA download over the Air to send the right object from the rights issuer to the receiver.

7. The method as claimed in claim 6, wherein step (C) comprises the steps of:
(C1) the rights issuer notifying the receiver of acquiring the right object;
(C2) the receiver acquiring the right object; and
(C3) the receiver sending a download complete signal to the rights issuer to thereby end a transfer between the receiver and the rights issuer.

8. The method as claimed in claim 7, wherein an RSA algorithm is applied to encrypt and decrypt the transfer between the receiver and the rights issuer.

9. The method as claimed in claim 8, wherein the receiver uses a public key of the rights issuer to decrypt the right object.

10. A method for an Open Mobile Alliance (OMA) multimedia exchange, which allows a sender to send a multimedia data to a receiver via a rights issuer, the method comprising the steps of:
(A) the sender registering to the rights issuer and sending a pubic key of the sender to the rights issuer, and the rights issuer sending a public key of the receiver to the sender;
(B) the sender assigning an rights issuer uniform resource locator (RI_URL) field of a content object to a URL of the sender, and encrypting a right object with the public key of the receiver and then encrypting the right object with a private key of the sender to thereby produce an encrypted right object;
(C) the sender packaging the content object into a DRM content format (DCF) object and sending the encrypted right object and the DCF object to the receiver;
(D) the receiver sending a right object request to the rights issuer in accordance with the RI_URL field of the content object when an identification of the encrypted right object fails; and
(E) the rights issuer activating a four-pass registration in accordance with the RI_URL field of the content object and sending the public key of the sender to the receiver.

11. The method as claimed in claim 10, further comprising the step of:
(F) the receiver using the public key of the sender to identify the encrypted right object.

12. A method for an Open Mobile Alliance (OMA) multimedia exchange, which allows a sender to send a multimedia data to a receiver via a rights issuer, the method comprising the steps of:
(A) the sender registering to the rights issuer and sending a first pubic key of the sender to the rights issuer, and the rights issuer sending a second public key of the receiver to the sender;
(B) the sender assigning an rights issuer uniform resource locator (RI_URL) field of a content object to a URL of the sender, and encrypting a right object with the second public key of the receiver first and then encrypting the right object with a private key of the sender to thereby produce an encrypted right object;
(C) the sender packaging the content object into a DRM content format (DCF) object and sending the DCF object to the receiver;
(D) the receiver sending a right object request to the rights issuer in accordance with the RI_URL field of the content object;
(E) the rights issuer activating a four-pass registration in accordance with the RI_URL field of the content object and sending the first public key of the sender to the receiver; and
(F) the rights issuer producing a right object acquisition protocol trigger event to the receiver and sending the encrypted right object to the receiver.

13. The method as claimed in claim 12, further comprising the step of:
(G) the receiver using the first public key of the sender to identify the encrypted right object.
